(19) United States
(12) Patent Application Publication
(10) Pub. No.: US 2017/0091636 A1
(43) Pub. Date: Mar. 30, 2017

(54) METHOD FOR AUTOMATED WORKFLOW AND BEST PRACTICES EXTRACTION FROM CAPTURED USER INTERACTIONS FOR OILFIELD APPLICATIONS

(71) Applicant: SCHLUMBERGER TECHNOLOGY CORPORATION, Sugar Land, TX (US)

(72) Inventors: Valery Polyakov, Brighton, MA (US); David Brock, Natick, MA (US)

(21) Appl. No.: 15/274,675

(22) Filed: Sep. 23, 2016

Related U.S. Application Data
(60) Provisional application No. 62/232,772, filed on Sep. 25, 2015.

(51) Int. Cl. G06N 5/04; E21B 41/00

(52) U.S. Cl. CPC G06N 5/047; E21B 41/0092

(57) ABSTRACT

Workflow extraction systems, methods, and computer readable mediums are described herein. The system includes a client that executes an oilfield service application and a recording module that receives and records messages from the client. The messages include user actions performed in the oilfield service application and/or the client. The system further includes a recognition module that determines a pattern using the recorded messages and a workflow creation module that generates a package using a detected pattern.

### RELATED APPLICATIONS

This application claims the benefit of U.S. Provisional Application Ser. No. 62/232,772 filed on Sep. 25, 2015, which is hereby incorporated by reference herein in its entirety.

### BACKGROUND

Users of petrotechnical applications—spanning all domains of upstream business from drilling simulation, seismic, well placement, reservoir characterization, reservoir simulation, fracture modeling, geological modeling, gridding and upscaling, well and completion design to production design and optimization, etc.—deal with vast variety of data that can be conditioned, processed, and interpreted in multitude of ways, and in a multitude of workflows. The field is so wide that becoming an expert modeler, petrophysicist, reservoir engineer, etc., often means specializing in a limited number of workflows, as it is impossible to grasp the entire domain. Experts often perform actions in their work that they consider to be the best ways to perform a particular workflow.

### SUMMARY

In general, in one aspect, one or more embodiments disclosed herein relate to a workflow extraction system. The system includes a client that executes an oilfield service application and a recording module that receives and records messages from the client. The messages include user actions performed in the oilfield service application and/or the client. The system further includes a recognition module that determines a pattern using the recorded messages and a workflow creation module that generates a package using the detected pattern.

In another aspect, one or more embodiments disclosed herein relate to a workflow extraction method. The method includes receiving messages from a user. The messages include user actions performed in an oilfield service application and/or a client. The method further includes recording the messages and analyzing the recorded messages for a pattern. A package is generated using the detected pattern. The package causes an oilfield asset to perform actions that correspond to the detected pattern.

In another aspect, one or more embodiments disclosed herein relate to a computer implemented method for automated workflow. The method includes receiving, from a client executing an oilfield service application, inputs from a user to initiate an oilfield operation. The method also includes recording messages that include interactions between the user and the oilfield service application and determining, by a processor, that the interactions correspond to an oilfield operation pattern. The method further includes receiving confirmation, from the client, that the interactions correspond to the oilfield operation pattern and storing the oilfield operation pattern in a memory for use in a subsequent oilfield operation.

In yet another aspect, one or more embodiments disclosed herein relate to a computer implemented method for automated workflow. The method includes receiving, from a client executing an oilfield service application, inputs from a user to initiate an oilfield operation and recording messages that include interactions between the user and the oilfield service application. The method also includes determining, by a processor, that the interactions correspond to an oilfield operation pattern and receiving confirmation, from the client, that the interactions correspond to the oilfield operation pattern. The method further includes storing the oilfield operation pattern in a memory for use in a subsequent oilfield operation.

Other aspects and advantages will be apparent from the following description and the appended claims.

### BRIEF DESCRIPTION OF DRAWINGS

FIG. 1 shows an automated workflow and best practices extraction system according to one or more embodiments.

FIG. 2 shows an automated workflow and best practices extraction method according to one or more embodiments.

FIG. 3 shows an automated workflow and best practices extraction method according to one or more embodiments.

FIG. 4 shows an automated workflow and best practices extraction method according to one or more embodiments.

FIG. 5 shows a message log of an automated workflow and best practices extraction system according to one or more embodiments.

FIG. 6 shows an example message sequence of an automated workflow and best practices extraction system according to one or more embodiments.

FIG. 7A shows a screenshot of an example software application that is used in conjunction with an automated workflow and best practices extraction system according to one or more embodiments.

FIG. 7B shows a screenshot of an example software application that is used in conjunction with an automated workflow and best practices extraction system according to one or more embodiments.

FIG. 7C shows a screenshot of an example software application that is used in conjunction with an automated workflow and best practices extraction system according to one or more embodiments.

FIG. 7D shows a screenshot of an example software application that is used in conjunction with an automated workflow and best practices extraction system according to one or more embodiments.

FIG. 8A shows a sequence of messages according to one or more embodiments.

FIG. 8B shows the message sequence of FIG. 8A recorded in graph form according to one or more embodiments.

### DETAILED DESCRIPTION

Specific embodiments will now be described in detail with reference to the accompanying figures. Like elements in the various figures are denoted by like reference numerals for consistency. Like elements may not be labeled in all figures for the sake of simplicity.

In the following detailed description, numerous specific details are set forth in order to provide a more thorough understanding of one or more embodiments of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create a particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a”, “an”, and “the” include plural referents unless the context clearly dictates otherwise. Thus, for example, reference to “a vehicle” includes reference to one or more of such vehicles. Further, it is to be understood that “or”, as used throughout this application, is an inclusive or, unless the context clearly dictates otherwise.

Terms like “approximately”, “substantially”, etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

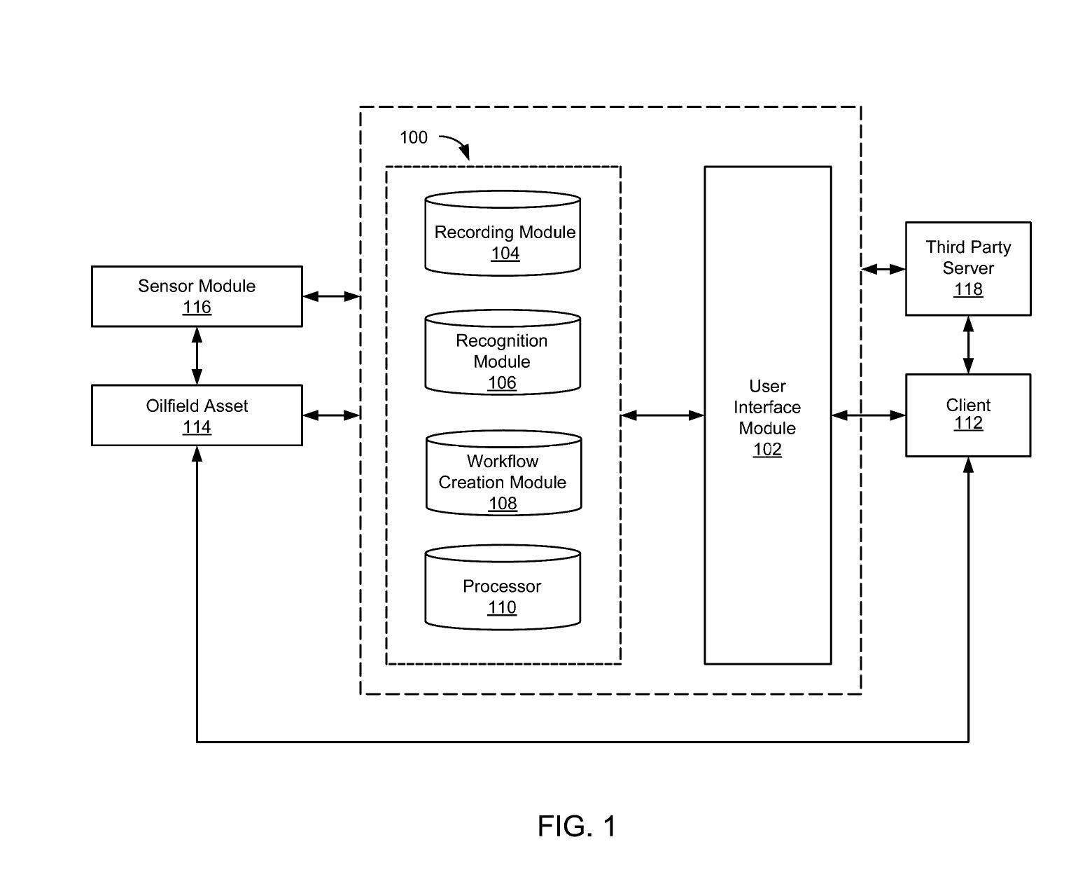

FIG. 1 shows an automated workflow and best practices extraction system according to one or more embodiments. The system includes multiple components, including, but are not limited to, an automated workflow and best practices extraction server (100), a user interface module (102), a client (112), an oilfield asset (114), a sensor module (116), and a third party server (118). In one or more embodiments, the automated workflow and best practices extraction server (100) may further include, for example, a recording module (104), a recognition module (106), a workflow creation module (108), a processor (110), etc. Of course, one of ordinary skill in the art would appreciate that the system may comprise additional components or may carry out intended functions without certain illustrated components without departing from the scope of the disclosure. For example, one of ordinary skill in the art would appreciate that the system may additionally comprise a memory (not shown). In one or more embodiments of the disclosure, the memory may be, for example, random access memory (RAM), cache memory, flash memory, etc.

FIG. 1 further illustrates that the components may communicate, either wired- or wirelessly, with one another either directly or indirectly. Furthermore, although certain components are shown to be only communicating indirectly, one of ordinary skill in the art would appreciate that a direct communication between the two components does not depart from the scope of the disclosure. For example, the oilfield asset (114) may or may not directly communicate with client (112). The communication that takes place among the components may include, for example, transmission of information, receipt of information, storage of information, etc. Each of these components are now described below in more details.

In one or more embodiments, the automated workflow and best practices extraction server (100) operates within a client-server architecture to receive and process requests. The server may be a general-purpose server or may be a specific application server dedicated to executing certain software applications. Of course, one of ordinary skill in the art would appreciate that the server may be a collection of servers that include an application server, a communication server, a database server, etc. The automated workflow and best practices extraction server (100) may be housed in a remote data center or may be in close proximity to other components of the automated workflow and best practices extraction system.

In one or more embodiments, the recording module (104) may be an application or a hardware recording medium that records a user action within the automated workflow and best practices extraction system. Such user actions may be recorded and organized in any data structure type, including, but not limited to, arrays, linked lists, hash tables, graphs, such as directed graphs, and stored as entities in a relational, non-relational (“nosql”), or graph database. For the purposes of discussion only, user actions are stored in a “table” and stored application actions (such as user interactions) are also referred to as messages. Messages may include (i) text strings that had been processed as application actions, (ii) rows in a relational database where individual parts of the message are in columns and relationships between them are expressed through primary and foreign keys, (iii) documents in a “nosql” database, an/or (iv) nodes and edges of a (directed) graph. Messages stored within the table are not limited and may include, for example the fact that a user has clicked on a particular radio button associated with the user interface module (102), an internet protocol (IP) address associated with the clicking, a physical location associated with the clicking (may be obtained by cellular networks, may be obtained by global positioning systems, or may be obtained based on the IP address), a timestamp associated with the clicking, an action that took place before the clicking, an action that took place after the clicking, etc. For example, the table may further indicate that the user has switched browsers (e.g., from CHROME® to FIREFOX®). For example, the table may further indicate that the user has opened, closed, minimized, dragged, resized, etc., a window. For example, the table may further indicate that the user has executed a particular software application, executed a particular script, tag, extension, etc. For example, the table may further indicate a path of a cursor movement, a duration of the cursor movement, a distance of the cursor movement (which could be measured in, for example, pixels) etc. For example, the table may further indicate that the user's cursor is at a first coordinate on the client (112). For example, the table may further indicate that the user has moved the cursor from the first coordinate to a second coordinate. For example, the table may further indicate that the user has done at least one of: clicked, double-clicked, right-clicked, left-clicked, scrolled, highlighted, bolded, italicized, inputted in, etc., a particular object. The object is not limited and may include, for example, an ASCII character, a picture, a radio button, a line, a bar chart, and any element that constitutes a portion of a user interface (UI) and/or a graphic user interface (GUI). The particular message to be stored in the table may be set to default or may be configurable by the user. Specifically, in one or more embodiments, the user may indicate that only clicks be logged. In one or more embodiments, the user may further indicate that, when the clicks are logged, a timestamp be associated with each click. One of ordinary skill in the art would appreciate that the examples listed above are by no means exhaustive and that the recording module (104) is capable of recording any and all human-machine interactions from determining an optimal positioning of windows in an application to selection of certain display elements (e.g., log tracks, crossplots, 3D windows, etc.) to configuring simulation parameters or data processing.

In one or more embodiments, the recognition module (106) may be an application, a code stored on a non-transitory storage medium, etc., configured to parse and determine a pattern within the messages logged by the recording module (104). The patterns to be parsed and determined by the recognition module are not limited. The patterns may be text-based, movement-based, input-based, context-based, etc. Each interaction type is now explained.

In one or more embodiments, text-based recognition may be, for example, determining the most frequently entered number/string and their input intervals, determining a repetition of entered strings/values (for example, the user frequently enters “a” after having entered “159” and “Run”), etc. Depending on the difficulty of the task and the setting of the recognition module (106), statistical natural language processing may be introduced to, based on the user's historical inputs, prompt the user to take certain actions (which can include, but are not limited to, accepting an autocomplete proposal, accepting a particular action, opening a dialogue window, minimizing a window, exiting a window, etc.). The setting of the recognition module (106) is configurable by the user and may be set to highly sensitive (i.e., lowering a threshold for determining the existence of a pattern (the threshold may be, for example, a predetermined number of times the user enters the sequence within a predetermined period of time)) or to minimally sensitive (i.e., increasing a threshold for determining the existence of a pattern). In one or more embodiments, text-based recognition may be semantically parsing the messages, processing the messages using natural language processing techniques, and determining a pattern based on the meanings of the messages.

In one or more embodiments, movement-based recognition may be, for example, determining that the user moves a cursor between approximately a first coordinate and approximately a second coordinate approximately every predetermined amount of time, determining that the user's cursor always goes from a third coordinate to a fourth coordinate to a fifth coordinate, then to a sixth coordinate, determining that the third coordinate, the fourth coordinate, the fifth coordinate, and the sixth coordinate form a particular parallelogram in shape, etc. As discussed above, the setting of the recognition module (106) is configurable by the user and may be set to highly sensitive (i.e., lowering a threshold for determining the existence of a pattern (the threshold may be, for example, a predetermined number of times that the user forms the parallelogram within a predetermined amount of time)) or to minimally sensitive (i.e., increasing a threshold for determining the existence of a pattern).

In one or more embodiments, input-based recognition may be, for example, determining that the user clicks at approximately the first coordinate every predetermined amount of time, determining that the user usually clicks the second coordinate once after double-clicking the third coordinate, determining that the clicking the second coordinate is held for at least 3 seconds, etc. As discussed above, the setting of the recognition module (106) is configurable by the user and may be set to highly sensitive (i.e., lowering a threshold for determining the existence of a pattern (the threshold may be, for example, a predetermined number of times when the user performs the behavior of clicking the second coordinate for at least 3 seconds after having double-clicked the third coordinate within a predetermined amount of time)) or to minimally sensitive (i.e., increasing a threshold for determining the existence of a pattern).

In one or more embodiments, context-based recognition may be, for example, determining that, in an oilfield software application for example, the user always selects a particular line out of a plurality of lines shown in a graph for further processing, determining that the user always uses the metric system as units of measurement, determining that the user always adds a particular chemical additive after having mixed fracking fluid, determining that opening a blender gate is always performed prior to mixing fracking fluid, determining that a particular procedure is always performed in parallel with another procedure, determining that, upon acquiring a particular set of data, that data is always converted to a particular file format for further processing etc. As discussed above, the setting of the recognition module (106) is configurable by the user and may be set to highly sensitive (i.e., lowering a threshold for determining the existence of a pattern (the threshold may be, for example, a predetermined number of times when the user opens a blender gate before he mixes fracking fluid within a predetermined amount of time)) or to minimally sensitive (i.e., increasing a threshold for determining the existence of a pattern). One of ordinary skill in the art would appreciate that the oilfield software application is not limited to a particular domain or purpose and may facilitate, for example, well placement, borehole design, borehole integrity, properties modeling (e.g., petrophysical, geometrical, reservoir, seismic, etc.), seismic interpretation, well logs interpretation (e.g., forward modeling, inversion, etc.), uncertainty and optimization modeling, structural modeling (e.g., fault modeling, gridding, etc.), fracture modeling, reservoir simulation (e.g., production modeling, history matching, etc.), and stratigraphy modeling (e.g., facies, etc.), to name a few.

In one or more embodiments, the threshold is to be met/exceeded for a pattern to be recognized. As indicated above, the threshold can vary to adjust what the recognition module (106) considers to be a pattern. In certain instances, a complete match of the recurring sequence identical to messages ABCDEF is considered to be a pattern. In other instances, the recognition module (106) may consider a partial match of ABCDEFG to be a pattern as messages E and G may contain varying parameters.

In one or more embodiments, the pattern recognition module (106) can analyze the messages by querying a relational database through a series of complex joints or by querying a graph database and using one or more pattern recognition algorithms to identify a pattern or patterns in the sequence of messages. In one example, a repeating sequence of messages can be discovered in a relational database that has the following schema (in pseudo-code):
table: Actor (string name)
table: message (Actor from, Actor to, string method, string subject, string content)

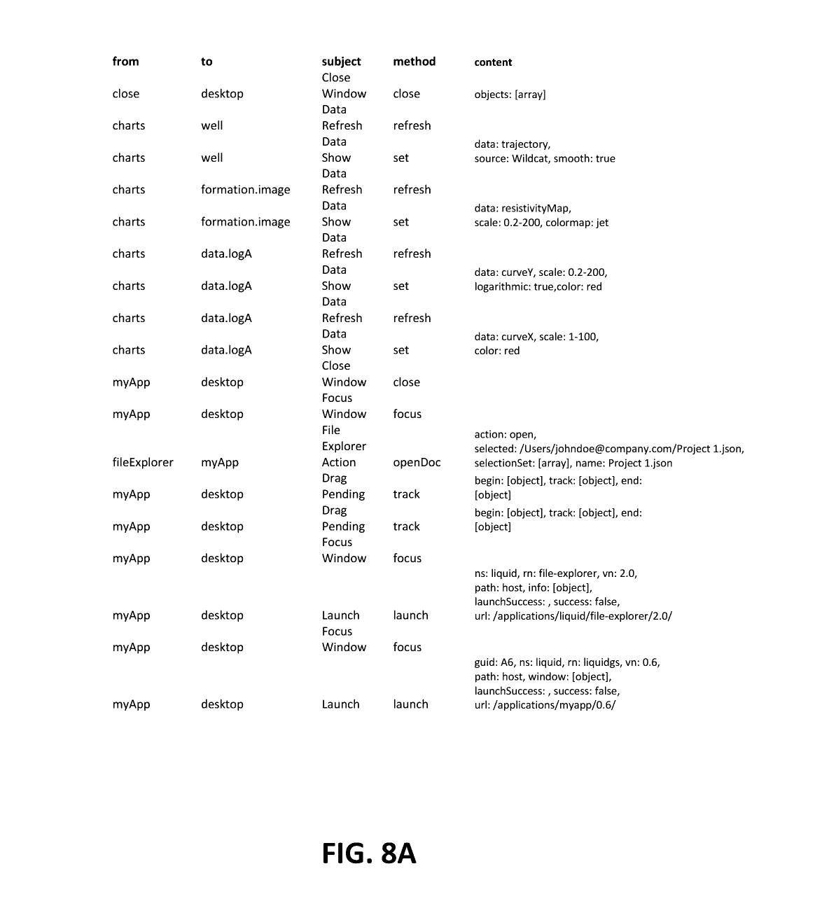

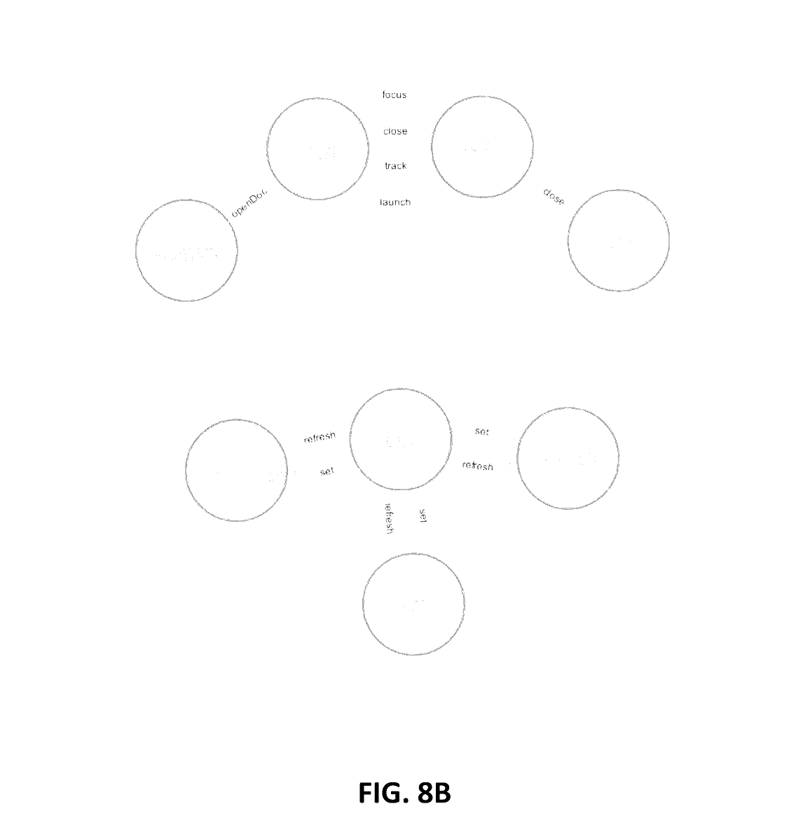

An example of such a repeating sequence of messages is shown in FIG. 8A.

In this example, the pattern recognition module (106) found a repeating pattern that includes (i) launching an application “myapp”, (ii) setting the focus to the application, launching a file explorer, opening a project file, (iii) setting the focus to the charts component, (iv) selecting a well log (A), (v) displaying a log curve (X) on a scale of 1 to 100, (vi) displaying a second log curve (Y) a scale of 0.2 to 200, (vii) displaying a formation, (viii) displaying a well trajectory, and (ix) closing the application window.

Alternatively or additionally, if the messages are recorded in graph form, the patterns may be discovered by querying a graph database. FIG. 8B shows the message sequence of FIG. 8A recorded in graph form. These messages, if repeated, can be deemed to form a pattern. Details of querying patterns in graphs can be found in Pablo Barceló, et al., Querying Graph Patterns, Proceedings of the Thirtieth ACM SIGMOD-SIGACT-SIGART Symposium on Principles of Database Systems ACM 199 (2011). Further details of querying patterns in acyclic graphs can be found in Anna Fariha, et al., Mining Frequent Patterns from Human Interactions in Meetings using Directed Acyclic Graphs, Pacific-Asia Conference on Knowledge Discovery and Data Mining 38 (2013).

The examples provided above are by no means exhaustive and that any pattern, regardless of whether it be clicking a button in a particular rhythm or commanding oilfield assets to operate in a particular manner, may be parsed and determined by the recognition module (106). Furthermore, one of ordinary skill in the art would appreciate that the various modes of recognition (e.g., text-based, movement-based, input-based, context-based, etc.) are not exhaustive and may be used in combination to parse and determine patterns within the automated workflow and best practices extraction system. Specifically, for example, the recognition module (106) may determine that the user, using the cursor and in sequence, double clicks the first coordinate, enters a particular value as input for an equation, plots outputs of the equation, stores data points of a line (out of a plurality of lines) having the greatest slope generated from the plot, and then minimizes the software application window. For example, patterns of patterns may also be detected by the recognition module (106). That is, the recognition module (106) may recognize that a first workflow is always preceded by a second workflow and that the first workflow is always followed by a third workflow.

In one or more embodiments, the workflow creation module (108) may be an application, a code stored on a non-transitory storage medium, etc., configured to organize the patterns detected by the recognition module (106) and package the same into a useable format. For example, the workflow creation module (108) may package a particular pattern into an application, a plug-in, an extension, a script, a tag, etc., so that the patterns can be utilized by other individuals who download them. In one or more embodiments, the workflow creation module (108) may automatically combine patterns to form a package if it (108) determines that there is a logical arrangement. Upon executing the package, a second user is able to perform the exact same task as the user did. For example, if a particular package is moving a cursor from a first coordinate to a second coordinate and then to a third coordinate, the second user, upon having executed the package on the client of the second user, may also cause the cursor to move in the same manner (from the first coordinate to the second coordinate and then to the third coordinate). The workflow creation module (108) may further transmit and publish the package as an application, a plug-in, an extension, a script, a tag, etc., on the third party server (118). The packages of patterns may be automatically reconfigured to adjust for display size, processor speed, etc.

In one or more embodiments, the processor (110) executes the applications, the codes described above. The processor (110) may be an integrated circuit for processing. Further, the processor may be one or more cores, or micro-cores of a processor.

In one or more embodiments, the user interface module (102) may be a software application or a set of related software applications configured to communicate with external entities (e.g., the client (112)). The user interface module (102) may include the application programming interface (API) and/or any number of other components used for communicating with entities both outside and inside of the automated workflow and best practices extraction system. The API may include any number of specifications for making requests from and/or providing data to the automated workflow and best practices extraction system. For example, a function provided by the API may provide autocomplete recommendations to a requesting client (112).

In one or more embodiments, the user interface module (102) is configured to use one or more of the data repositories (not shown) of the automated workflow and best practices extraction server (100) to define information and presentation format of the same to the client (112). A user may use any client (112) to receive information from the user interface module (102). For example, where the user uses a web-based client to interface with the user interface module (102), an API of the user interface module (102) may be utilized to define web-based information for presentation to the client (112). Similarly, different forms of delivery may be handled by different modules in the user interface module (102). In one or more embodiments, the user may specify particular receipt preferences, which are also implemented by the user interface module (102).

In one or more embodiments, the client (112) may be any hardware component capable of receiving, transmitting, processing, and displaying data. The client (112) may be, for example, a mainframe, a desktop Personal Computer (PC), a laptop, a Personal Digital Assistant (PDA), a telephone, mobile phone, a kiosk, a cable box, and any other device.

In one or more embodiments, the oilfield asset (114) may be a wellhead, a high pressure line, a bleed off line, a fracturing pump, a sensor module, a blender, a chemical additive reservoir, an oilfield asset monitoring system (which may include the sensor module (116)), a fracturing tank, a proppant deposit, etc. For example, the sensor module (116) may include an infrared sensor, a luminescence sensor, an ultrasonic sensor, etc.

In one or more embodiments, the sensor module (116) may be any transducer. The sensor module (116) may be configured to measure one or more parameters associated with the oilfield asset (114), a surrounding condition associated with the oilfield asset (114) (e.g., well, borehole, etc.). The sensor module may comprise various sensors including an image acquisition module (e.g., camera), an infrared sensor, a luminescence sensor, an ultrasonic sensor, a piezoelectric sensor, etc. The sensor module (116) may facilitate measurement of properties including, but not limited to, pressure, fluid flow rate, temperature, vibration, composition, fluid flow regime, fluid holdup, etc.

In one or more embodiments, the third party server (118) is a server that belongs to a system outside of the automated workflow and best practices extraction system. The third party server may be hosted and/or may be maintained by a third party that has contractual agreements with the automated workflow and best practices extraction system. Said in another way, the third party server (118) belongs to an entity that is different from the entity that operates the automated workflow and best practices extraction system. The third party server (118) may be a system configured to receive the package created by the workflow creation module (108) and publish the same. The publication of the package by the third party server (118) enables users from within and outside the automated workflow and best practices extraction system to download published packages. In one or more embodiments, the third party server may be a digital distribution platform for distribution of packages (also referred to as applications). The applications provide a specific set of functions. The applications may be designed to be executed on specific devices and may be written for a specific operating system. The publication of the packages/applications by the third party server (118) may be subject to an approval process. The packages may be transmitted to any server (third party or not) and that the same may be published by any entity (third party or not) subject to the user settings of the automated workflow and best practices extraction system.

Turning to the flowcharts, while the various stages in the flowcharts are presented and described sequentially, one of ordinary skill will appreciate that some or all of the stages may be executed in different orders, may be combined or omitted, and some or all of the stages may be executed in parallel.

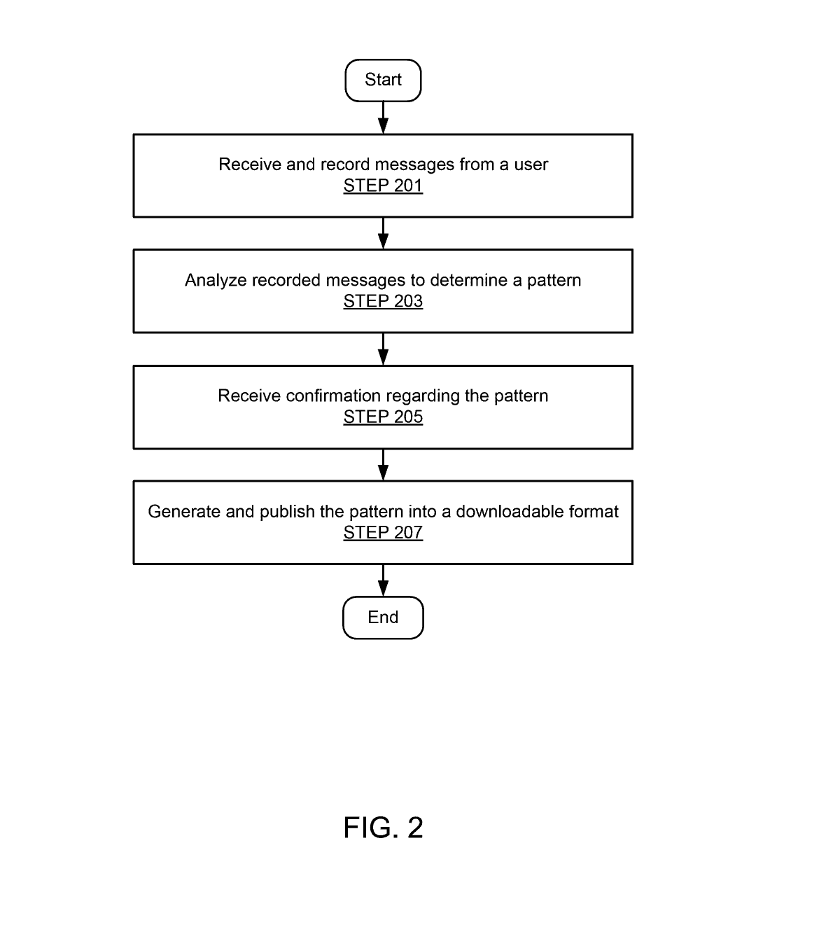

FIG. 2 shows an automated workflow and best practices extraction method according to one or more embodiments.

In Stage 201, messages (user actions) are received and recorded by a recording module. In one or more embodiments, the messages may be continuously saved. In one or more embodiments, the messages may be selectively saved depending on user setting. As discussed above, the contents of the messages vary and can include, for example, “move the cursor 1 pixel to the left on the screen,” “execute reservoir modeling application,” etc. In one or more embodiments, all actions may be summarized (e.g., “cursor moved from coordinate A to coordinate B,” “double-clicked line X in application Y at time Z,” etc.) and compiled into a log so that another user may be able to read the log and determine what actions have been taken by the user.

In Stage 203, recorded messages from Stage 201 are analyzed to determine whether there exists a pattern. Definition of the term “pattern” has been explained and will be omitted for the sake of brevity. In one or more embodiments, the recorded messages may be analyzed in real-time or may be analyzed in batches to optimize processing load. The messages may be analyzed for frequency, recurring patterns, and/or semantics.

In Stage 205, upon determining that there is a pattern, the method prompts the user to confirm whether a detected pattern is indeed a pattern. The dialogue displayed to the user may be “You appear to be an expert, is this the standard operating procedure?” In one or more embodiments, the user may agree or dismiss the prompt. In one or more embodiments, the user may agree in part and choose to modify certain portions of the detected pattern as the pattern.

In Stage 207, upon receiving confirmation from the user that the detected pattern is a pattern, the method proceeds to generate and publish the detected pattern into a downloadable format. The downloadable format may be forwarded to a third party server so that the detected pattern can be published by the third party server and accessed and executed by users outside of the automated workflow and best practices extraction system.

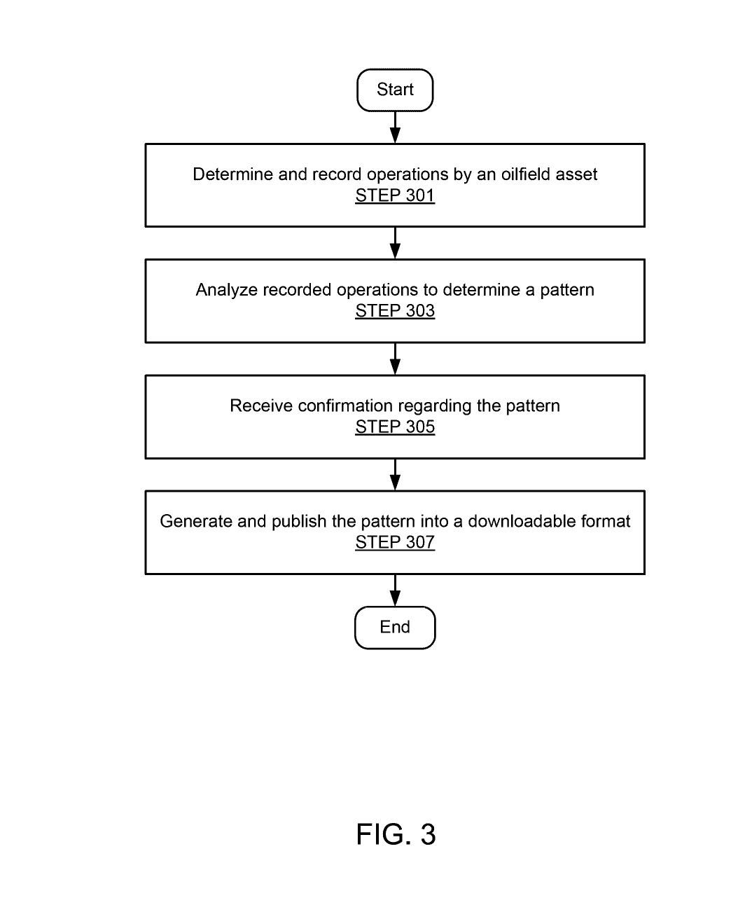

FIG. 3 shows an automated workflow and best practices extraction method according to one or more embodiments.

In Stage 301, operations performed by an oilfield asset are determined and recorded. In one or more embodiments, all actions may be summarized and compiled into a log so that another user may be able to read the log and determine what operations have been performed by the oilfield asset. An example entry of the log may be “open blender gates at 75%,” “add additive X per schedule,” etc.

In Stage 303, similar to Stage 203, recorded operations from Stage 301 are analyzed to determine whether there exists a pattern. Definition of the term “pattern” has been explained and will be omitted for the sake of brevity. In one or more embodiments, the recorded operations may be analyzed in real-time or may be analyzed in batches to optimize processing load. The operations may be analyzed for frequency, recurring patterns, and/or semantically. An example operation pattern may be, for example: (A) “operators radio check,” (B) “equipment state check,” (C) “material volumes check,” (D) “viscosity check” (E) “blender pressure,” (F) “open wellhead,” (G) “go to 1 bpm to check injectivity,” (H) “confirm injectivity,” (I) “inject base fluid adds,” (J) “go to 3 bmp for breakdown,” (K) “confirm breakdown,” (L) “go to 8 bmp and set blender to downhole,” (M) “confirm injectivity,” (N) “go to 10 bpm,” (O) “take a PAD example,” (P) “automatic fluid properties check,” (Q) “confirm good visuals on fluid,” (R) “adjust design rate,” (S) “current rate is going to be stage rate,” (T) “zero on PAD all densitometers,” (U) “open blender gates at 20%,” (V) “confirm visual gate position,” (W) “open blender gates at 50%,” (X) “confirm visual gate position,” (Y) “open blender gates at 80%,” (Z) “confirm visual gate position,” (i) “fill blender hopper with sand per predetermined schedule,” and (ii) “follow proppant and additives per schedule.”

In Stage 305, upon determining that there is a pattern, the method prompts the user to confirm whether a detected pattern is indeed a pattern. The dialogue displayed to the user may be “You appear to be an expert, is this (A-ii) the standard operating procedure?” In one or more embodiments, the user may agree or dismiss the prompt. In one or more embodiments, the user may agree in part and choose to modify certain portions of the detected pattern as the pattern.

In Stage 307, upon receiving confirmation from the user that the detected pattern is a pattern, the method may proceed to generate and publish the detected pattern into a downloadable format. The downloadable format may be forwarded to a third party server so that the detected pattern can be published by the third party server and accessed and executed by users outside of the automated workflow and best practices extraction system.

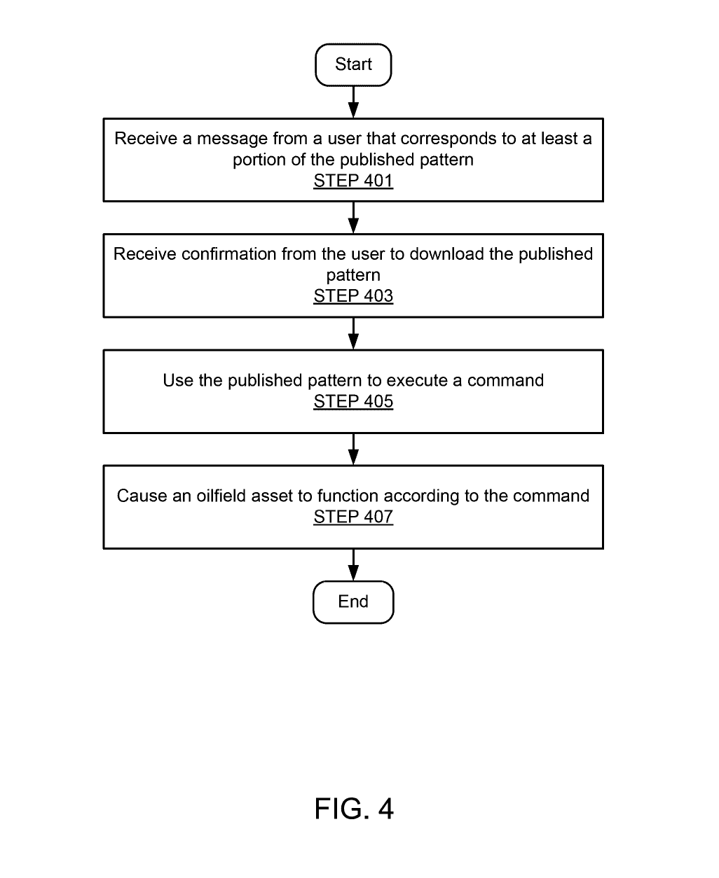

FIG. 4 shows an automated workflow and best practices extraction method according to one or more embodiments.

In Stage 401, the user takes an action and the same is received and stored as a message. The message may be parsed and determined to be a partial pattern of a previously detected pattern. For example, consider a scenario in which the automated workflow and best practices extraction method previously determined actions ABCDEFG to be a pattern and further consider that the user now takes actions ABCDE. In this case, the method may determine that there is a high probability that the user is attempting to complete the pattern ABCDEFG by later inputting actions F and G. Accordingly, the method may request confirmation from the user regarding whether he or she is about to take actions F and G to complete the pattern ABCDEFG.

In Stage 403, the user confirms that he or she is indeed attempting to complete the pattern ABCDEFG. Subsequently, in one or more embodiments, the pattern ABCDEFG may be downloaded from a third party server (if it is not already made available on the automated workflow and best practices extraction method). In one or more embodiments, where variables/parameters vary in particular stages, say G, the automated workflow and best practices extraction method may provide suggestions for setting those variables/parameters (which could be the most commonly used values for user action G). For example, upon detecting a series of actions up to setting blender to downhole, the method may determine “open blend gate” to be the next action. However, because the blend gate can be opened in a varied manner, the method may suggest that the user open blend gate at 20%, which happens to be the most frequently inputted value for this particular action in this pattern.

In Stage 405, the downloaded pattern is executed to perform a particular function. In one or more embodiments, if the pattern ABCDEFG is already stored in the automated workflow and best practices extraction system, the pattern may be autocompleted.

In Stage 407, an oilfield asset functions according to the executed pattern of

Stage 405. For example, upon receiving instructions to open the blend gate at 20%, the oilfield asset (the blend gate) opens at 20%.

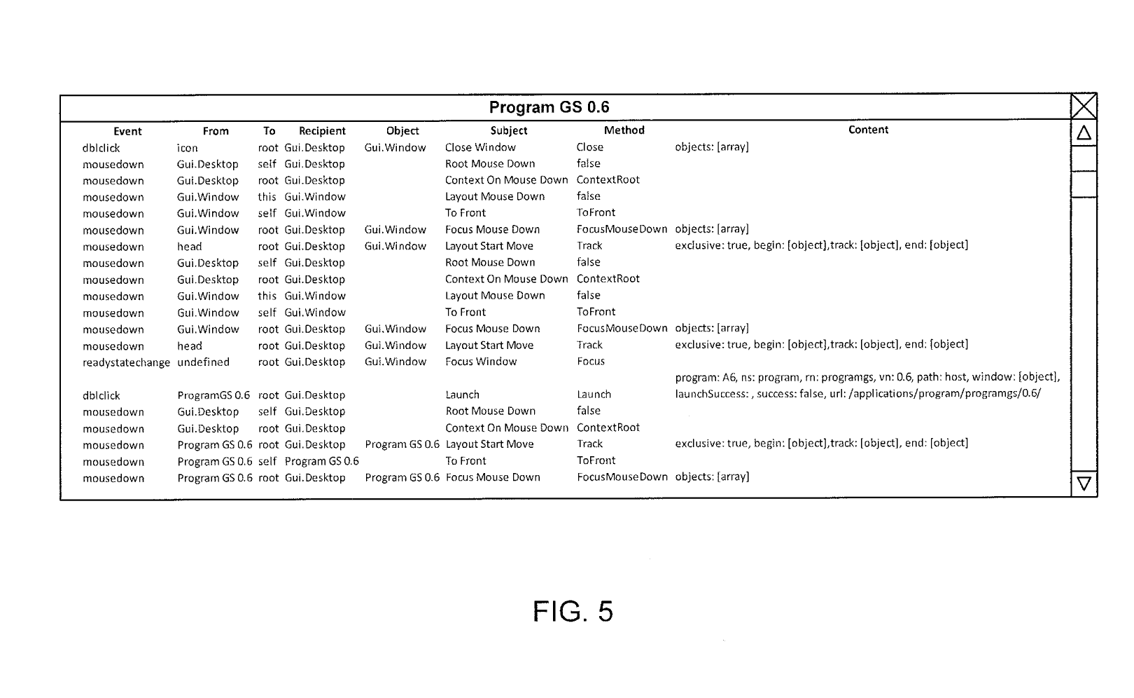

FIG. 5 shows a message log of an automated workflow and best practices extraction system according to one or more embodiments. Specifically, FIG. 5 illustrates an example screenshot of the messages captured and stored in a log. As discussed above, the log details some or all actions performed by a user operating a client. The log also includes his or her various interactions with the various applications, objects, etc. The log, for example, details a user action, an origin of the user action (e.g., graphic user interface window), a destination of the user action (e.g., graphic user interface desktop), an object (e.g., graphic user interface window), a subject, a method (e.g., close, track, launch, etc.), a physical location, a timestamp, etc.

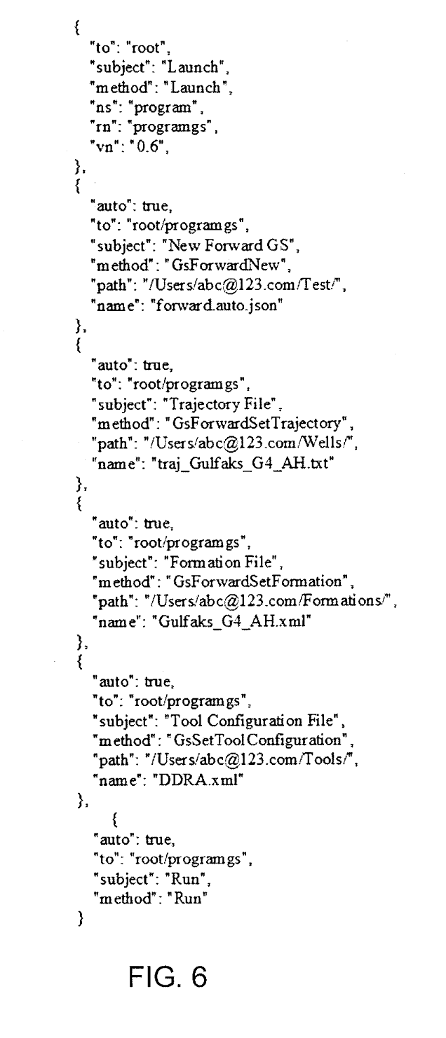

FIG. 6 shows an example message sequence of an automated workflow and best practices extraction system according to one or more embodiments. Specifically, FIG. 6 shows snippets of codes for executing a sequence of user actions. From the top to bottom, each code block respectively represents a user action: (A) launch application; (B) create a new forward project; (C) set trajectory file; (D) set formation file; (E) set tool configuration file; and, (F) execute forward simulation.

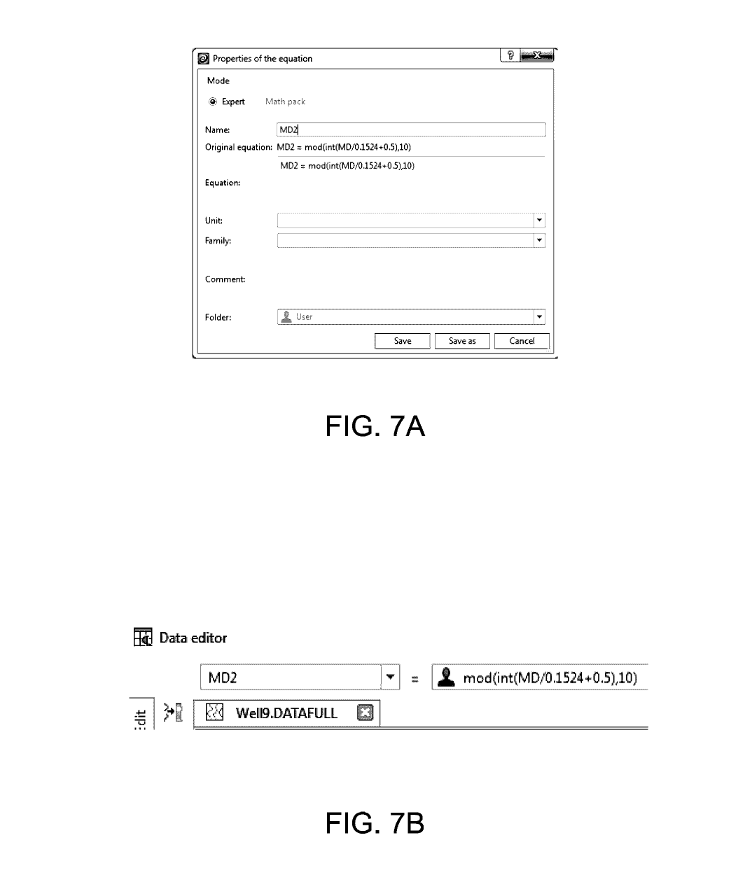

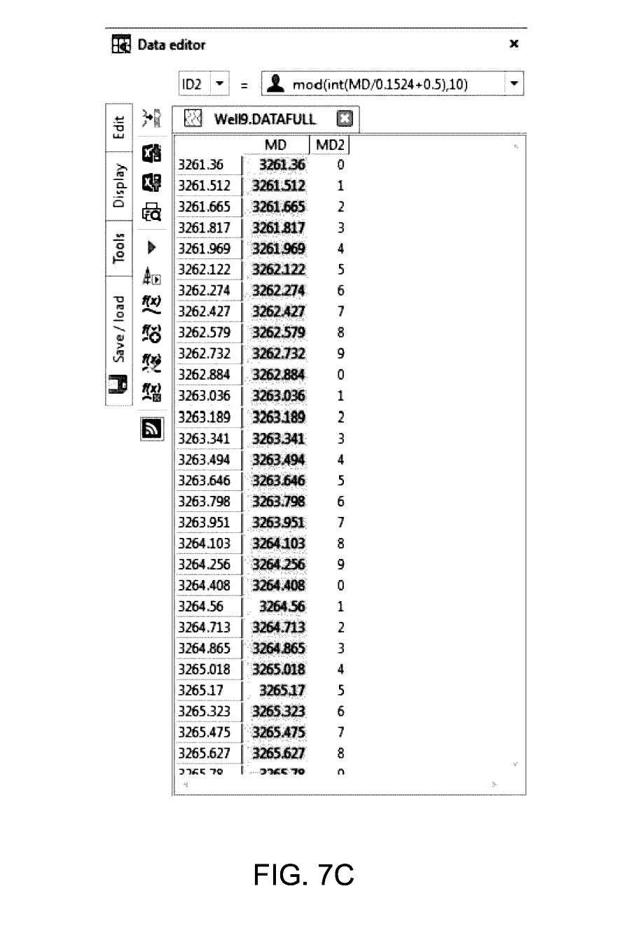

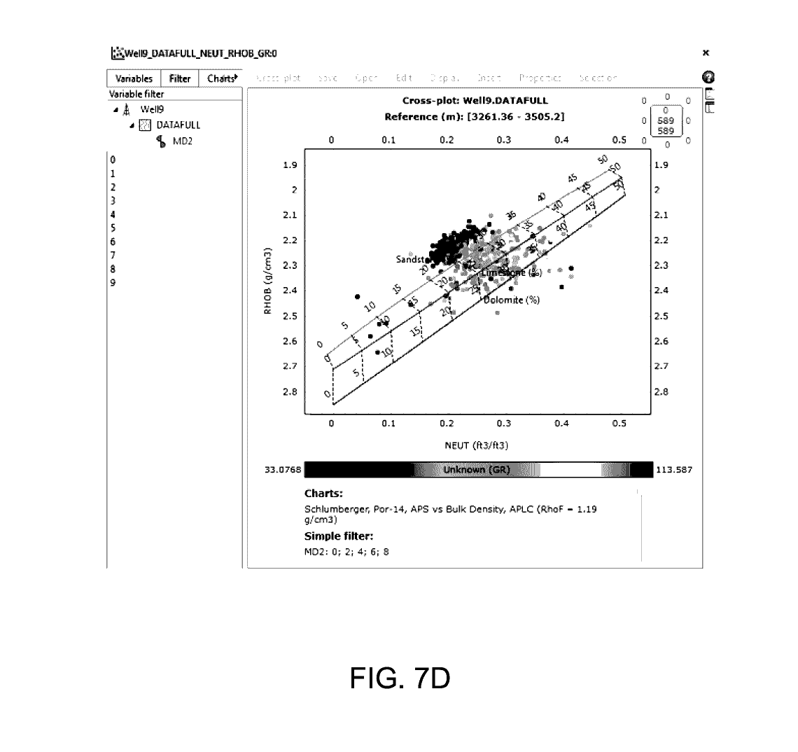

FIG. 7A shows a screenshot of an example software application that is used in conjunction with an automated workflow and best practices extraction system according to one or more embodiments. Specifically, FIG. 7A shows a pattern to downsample a variable for a crossplot to end up with fewer points to display. Actions involved in this pattern may be: (A) create equation; (B) set equation with parameters (e.g., text=MOD(int(MD/0.1524=0.5),10)) (See FIG. 7B); (C) create new property (e.g., parameter name=MD2); (D) apply equation (See FIG. 7C); (E) create crossplot; (F) choose crossplot filter; and (G) apply filter parameters.

FIG. 7B shows a screenshot of an example software application that is used in conjunction with an automated workflow and best practices extraction system according to one or more embodiments. FIG. 7B is an example of a graphic user interface representation of action (B) of the pattern relating to the description of FIG. 7A.

FIG. 7C shows a screenshot of an example software application that is used in conjunction with an automated workflow and best practices extraction system according to one or more embodiments. FIG. 7C is an example of a graphic user interface representation of action (D) of the pattern relating to the description of FIG. 7A.

FIG. 7D shows a screenshot of an example software application that is used in conjunction with an automated workflow and best practices extraction system according to one or more embodiments. FIG. 7D is an example of a graphic user interface representation of actions (E), (F), and (G) of the pattern relating to the description of FIG. 7A.

While the specification has been described with respect to one or more embodiments of the disclosure, those skilled in the art, having benefit of this disclosure, will appreciate that other embodiments can be devised which do not depart from the scope of the disclosure as disclosed herein.

For example, in one or more embodiments, the automated workflow and best practices extraction system may comprise a playback module. The playback module may be a code stored on a non-transitory storage medium, a software, and/or a hardware component. The playback module, upon storing, for example, an operation pattern ABCDEF may behave as follows:

Consider a scenario in which a user inputs actions A, B, and C and the automated workflow and best practices extraction system determines (based on, for example, thresholds, settings, and historical usage data) that the inputted actions A, B, and C correspond to stored actions A, B, and C and that there is high likelihood that the user is going to subsequently input actions D, E, and F. The playback module may, upon prompting the user and receiving confirmation from the user, automatically complete actions D, E, and F. In one or more embodiments, the playback module may, upon prompting the user and receiving confirmation from the user, automatically complete all actions ABCDEF. In one or more embodiments, the playback module may play the operation pattern without executing the same. This is so that another individual is able to observe the course of action undertaken by a previous user.

For example, although certain oilfield operations and stages within these operations have been discussed, one of ordinary skill in the art would appreciate that the disclosure can be applied to any and all petrotechnical applications that span across all domains of upstream business—from drilling simulation, seismic, well placement, reservoir characterization, reservoir simulation, fracture modeling, geological modeling, gridding and upscaling, well and completion design to production design and optimization, etc.

Furthermore, one of ordinary skill in the art would appreciate that certain “components”, “modules”, “units”, “parts”, “elements”, or “portions” of the one or more embodiments of the disclosure are physical components and may be implemented by a circuit, processor, etc., using any known, or to-be developed, techniques, methods, etc.

What is claimed is:

1. A workflow extraction system, comprising:
a client configured to execute an oilfield service application;
a recording module configured to receive and record a plurality of messages from the client, wherein the plurality of messages comprise user actions performed in at least one of (i) the oilfield service application and (ii) the client;
a recognition module configured to determine a pattern using the plurality of recorded messages; and
a workflow creation module configured to generate a package using the detected pattern.

2. The workflow extraction system of claim 1, further comprising an oilfield asset, wherein the package is configured to cause the oilfield asset to perform actions that correspond to the detected pattern.

3. The workflow extraction system of claim 1, wherein the detected pattern is one of: text-based, movement-based, input-based, and context-based.

4. The workflow extraction system of claim 1, wherein the workflow creation module queries the client for user confirmation to determine the detected pattern.

5. The workflow extraction system of claim 1, wherein a threshold for determining the pattern is configurable by a user.

6. The workflow extraction system of claim 1, wherein the workflow creation module is configured to autosuggest a value for a parameter of a workflow based on historic usage data.

7. The workflow extraction system of claim 1, wherein the package is at least one selected from a group consisting of: a script, an application, a tag, a plug-in, and an extension.

8. The workflow extraction system of claim 1, wherein the package is transmitted to a third party server.

9. The workflow extraction system of claim 2, further comprising a sensor module for detecting an operation of the oilfield asset, wherein the operation is recorded by the recording module.

10. The workflow extraction system of claim 9, wherein:
the recognition module is configured to determine an operation pattern based on a plurality of recorded operations, and
the package is configured to be generated using a determined operation pattern.

11. The workflow extraction system of claim 1, wherein the recognition module is configured to determine a pattern by querying a graph database to identify a pattern within the plurality of recorded messages

12. A workflow extraction method, comprising:
receiving a plurality of messages from a user, wherein the plurality of messages comprise a plurality of user actions performed in at least one of (i) an oilfield service application and (ii) a client;
recording the plurality of messages;
analyzing the plurality of recorded messages for a pattern; and
generating a package using the detected pattern, wherein the package is configured to cause an oilfield asset to perform actions that correspond to the detected pattern.

13. The workflow extraction method of claim 12, wherein the detected pattern is one of: text-based, movement-based, input-based, and context-based.

14. The workflow method of claim 12, wherein, after the analyzing and before the generating, querying the client for user confirmation to determine the detected pattern.

15. The workflow extraction method of claim 12, wherein a threshold for determining the pattern is configurable by a user.

16. The workflow extraction method of claim 12, further comprising autosuggesting a value for a parameter of a workflow based on historic usage data.

17. The workflow extraction method of claim 12, wherein the package is at least one selected from a group consisting of: a script, an application, a tag, a plug-in, and an extension.

18. The workflow extraction method of claim 12, further comprising:
detecting an operation of the oilfield asset;
recording the operation as an operation message; and
determining an operation pattern based on a plurality of recorded operation messages,
wherein the package is configured to be generated using a determined operation pattern.

19. The workflow extraction method of claim 12, further comprising:
detecting an operation of the oilfield asset;
recording the operation as an operation message;
determining an operation pattern based on a plurality of recorded operation messages;
synchronizing the detected pattern with the operation pattern; and
modifying the package using a synchronized pattern.

20. A non-transitory computer readable medium comprising computer readable program code, which when executed by a computer processor, enables the computer processor to:
receive a plurality of messages from a user, wherein the plurality of messages comprise a plurality of user actions performed in at least one of (i) an oilfield service application and (ii) a client;
record the plurality of messages;
analyze the plurality of recorded messages for a pattern; and
generate a package using the detected pattern, wherein the package is configured to cause an oilfield asset to perform actions that correspond to the detected pattern.

21. A computer implemented method for automated workflow, the method comprising:
receiving, from a client executing an oilfield service application, inputs from a user to initiate an oilfield operation;
recording messages comprising interactions between the user and the oilfield service application;
determining, by a processor, that the interactions correspond to an oilfield operation pattern;
receiving confirmation, from the client, that the interactions correspond to the oilfield operation pattern; and
storing the oilfield operation pattern in a memory for use in a subsequent oilfield operation.

22. The method of claim 21, further comprising executing the oilfield operation pattern to replay the interactions between the user and the oilfield service application in the subsequent oilfield operation.

23. The method of claim 21, wherein the messages are each stored in a message log.

24. The method of claim 21, wherein the oilfield operation pattern causes an oilfield asset to execute a command that corresponds to a command of the oilfield operation pattern.

25. The method of claim 21, further comprising packaging the oilfield operation pattern as a package, wherein the package is at least one selected from of: a script, an application, a tag, a plug-in, and an extension.

26. The method of claim 25, wherein the package is transmitted to a third party server.

27. The method of claim 21, wherein the determining determines that the interactions correspond to the oilfield operation pattern after the user inputs the inputs for more than a predetermined number of times.

28. The method of claim 21, wherein the inputs are at least one of: text-based, movement-based, input-based, and context-based.

29. The method of claim 21, wherein a sensitivity for the determining the oilfield operation pattern is adjustable by the user.

30. The method of claim 22, wherein the executing replays a second portion of the interactions after determining that the user has inputted only a first portion of the interactions, the second portion follows the first portion and the interactions comprise the first portion and the second portion.
